(19) United States
(12) Patent Application Publication
(10) Pub. No.: US 2017/0105373 A1
(43) Pub. Date: Apr. 20, 2017

(54) FLUID FILTRATION AND DISTRIBUTION SYSTEM FOR PLANTING DEVICES

(71) Applicants: James Edgar Byron, III, Somerville, MA (US); Nicholas Sigifrido Ambrogi, Boston, MA (US); Nathaniel Robert Williams, Somerville, MA (US); Michael Gregg Zartarian, Belmont, MA (US); Layne Shriver Whitaker, Boxborough, MA (US)

(72) Inventors: James Edgar Byron, III, Somerville, MA (US); Nicholas Sigifrido Ambrogi, Boston, MA (US); Nathaniel Robert Williams, Somerville, MA (US); Michael Gregg Zartarian, Belmont, MA (US); Layne Shriver Whitaker, Boxborough, MA (US)

(21) Appl. No.: 15/294,357

(22) Filed: Oct. 14, 2016

Related U.S. Application Data
(60) Provisional application No. 62/241,675, filed on Oct. 14, 2015.

(51) Int. Cl. A01G 31/06; B01D 24/00; A01G 1/00; B01D 35/02

(52) U.S. Cl. CPC A01G 31/06; B01D 35/02; B01D 24/007; A01G 1/001; B01D 2101/04

(57) ABSTRACT

In some examples, a system for filtering and distributing fluid in a planting device comprises a first receptacle and a second receptacle. The first receptacle includes a first filter and a second filter. The second receptacle includes a first aperture and a second aperture. Fluid can enter the second receptacle through the first aperture and drain from the second receptacle through the second aperture to the second filter in the first receptacle. The system may include a pump configured to pump fluid from the first receptacle through the first filter to the first aperture of the second receptacle. Moreover, the system may include barriers that at least partially obstruct fluid flow between the first aperture and the second aperture. Each of the barriers includes a plurality of perforations located along a width of the barrier; each of the plurality of perforations allows fluid to flow through the barrier.

### CROSS-REFERENCE TO RELATED APPLICATION

This application claims the benefit of priority under 35 U.S.C. §119(e) to U.S. Provisional Application Ser. No. 62/241,675, entitled “SYSTEMS, METHODS, AND DEVICES FOR FACILITATING PLANT GROWTH” filed Oct. 14, 2015, which is hereby incorporated by reference in its entirety.

### TECHNICAL FIELD

The present disclosure relates generally to plant agriculture and, more particularly, to filtering and distributing fluid for plants growing in the fluid (e.g., employing techniques of hydroponics, aquaculture, and/or a combination thereof).

### BACKGROUND

Various techniques exist for growing plants in an aqueous environment. Hydroculture involves growing plants in an aqueous environment. In hydroculture, plants receive nutrients through water that is in contact with the plants roots. Hydroculture systems deliver water to the roots of a plant, often without soil. Therefore, the water is the primary source of nutrients for plants in systems hydroculture. Hydroponics is a specific type of hydroculture in which nutrient solutions (e.g., containing minerals or other chemical substances), in water, provide nutrients to plants growing in the water. In many hydroponic systems, the nutrient solutions are added to the water (referred to as “dosing”) to influence growth of the plants therein. Aquaponics combines hydroponics and the cultivation of aquatic organisms (e.g., fish). In aquaponic systems, biological waste from the aquatic organisms (and the byproducts from beak-down of the biological waste) to provide nutrients to the plants in the water. In ecoponics, other sources of biological waste (i.e., besides aquatic organisms) provide the basis for generating nutrients for the plants growing in the water. For example, excretions from worms, manure from livestock, or biological waste produced by any living organism may be used as a source of nutrients for plants. Each of the above techniques uses a fluid to provide nutrients to a plant and/or other organisms living in the fluid. Thus, the quality and distribution of the fluid is key to the survival of the plants and the other organisms in the water.

### BRIEF DESCRIPTION OF THE DRAWINGS

To provide a more complete understanding of the present disclosure and features and advantages thereof, reference is made to the following description, taken in conjunction with the accompanying Figures, wherein like reference numerals represent like parts, in which:

FIG. 1 is a simplified schematic diagram of a communication system for managing planting devices in accordance with some embodiments of the present disclosure;

FIG. 2 is a simplified diagram of a planting device in accordance with some embodiments of the present disclosure;

FIG. 3 is a simplified three-dimensional diagram of a planting device in accordance with some embodiments of the present disclosure;

FIG. 4 is a simplified three-dimensional diagram of a system for filtering and distributing fluid in the planting device of FIG. 3, in accordance with some embodiments of the present disclosure;

FIG. 5 is a rear view of the system of FIG. 4;

FIG. 6 is a top view of the system of FIG. 4;

FIGS. 7 and 8 are simplified diagrams of exemplary perforated barriers (or manifolds) for distributing fluid in a planting device, in accordance with some embodiments of the present disclosure; and

FIG. 9 is simplified three-dimensional exploded diagram of some components of a growth bed in accordance with some embodiments of the present disclosure.

### DESCRIPTION OF EXAMPLE EMBODIMENTS OF THE DISCLOSURE

### Example Embodiments

For many people, growing plants using any aqueous techniques (e.g., hydroculture, hydroponic, aquaponics, ecoponics, and other techniques) is challenging. Some planting devices provide a level of automation to aqueous techniques of growing plants. However, when a user attempts to operate such planting devices, they are faced with a challenge of managing the fluid within the system. The fluid in such a planting device can carry debris and other particles that must be removed to ensure the health of the plants and organisms growing in the fluid, to prevent clogging of valve, conduits, pumps, and the like, and to maintain clarity of the fluid. In addition, as the fluid is circulated through various receptacles in the planting device, the fluid is often pumped and drained though single spouts and/or drains, respectively, which can cause the fluid to “short circuit” in a shortest path from the spout to the drains (e.g., in a relatively direct path between the spout the drain). If such a short circuit occurs in a receptacle in which plants are growing, it can lead to an over-concentration of nutrients in along the direct path from the spout to the drain, and, consequently, to an under-concentration of nutrients outside of the direct path from the spout to the drain. In such a case, growth of the plant can be negatively impacted by such concentrations of nutrients.

A solution to the aforementioned challenges (and others) is a planting device that includes a system of multiple filtration mechanisms and perforated barriers between input and output valves in receptacles. The system of multiple filtration mechanisms removes debris at several locations throughout the planting device. Moreover, the filtration mechanisms being located at various locations throughout the planting device enables filtration to continue even if any one location is compromised. The perforated barriers between input and output valves in receptacles splits a single fluid flow into several pathways located parallel to the fluid flow direction (e.g., along the width of the receptacle). In effect, the barriers disrupt the “short circuit’ route for the fluid and facilitate distributing the fluid across a wider area in the receptacle based on the placement of the perforations in the barriers. The barriers behave like a manifold that splits the fluid flow from one into many flows.

A planting device is inclusive of a network connected device for growing plants in an aqueous environment (e.g., in a fluid). The plants may be, e.g., ornamental plants, edible plants, vegetables, fruiting crops, root crops, medicinal herbs, edible mushrooms, flowers, and the like. A planting device may include one or more receptacles for contain fluid. Some of the receptacles also contain organisms that live in the fluid. For example, one receptacle may include fish living in water. Another receptacle may contain plants growing in water (a “growing bed”). Each growing bed within the device may grow a different type of plant species (brassicas, nightshades, etc.), grow different phenotypes (e.g., leafy greens, vines, fruiting, large, small, tree, shrub, etc.), and/or implement a certain growing technique (e.g., micro-greens, fruiting, aeroponic, flood drain, aquaponic, wicking, hydroponic, deep water culture (DWC), nutrient film, soil-based, etc.) such that a user can customize their plant production to their needs or tastes. In some embodiments, the growing beds may share certain characteristics pertaining to electrical, plumbing, ventilation, and structural connections, such that they can be arranged in almost any interconnected configuration with a plug and play installation. The planting device can control one or more environmental variables and facilitates providing inputs (e.g., nutrients, air, water, etc.) to the plant. Environmental control hardware (lighting, irrigation, dosing, feeding, heating, cooling, ventilation, sensing, or other nodes) can be actuated with outputs that (approximately) match natural growing environments of each plant (e.g., mimic natural growing environments). Each planting device (and/or module) may transmit data over a network to a data center (e.g., enabling a mobile device to access and transmit commands to the planting device).

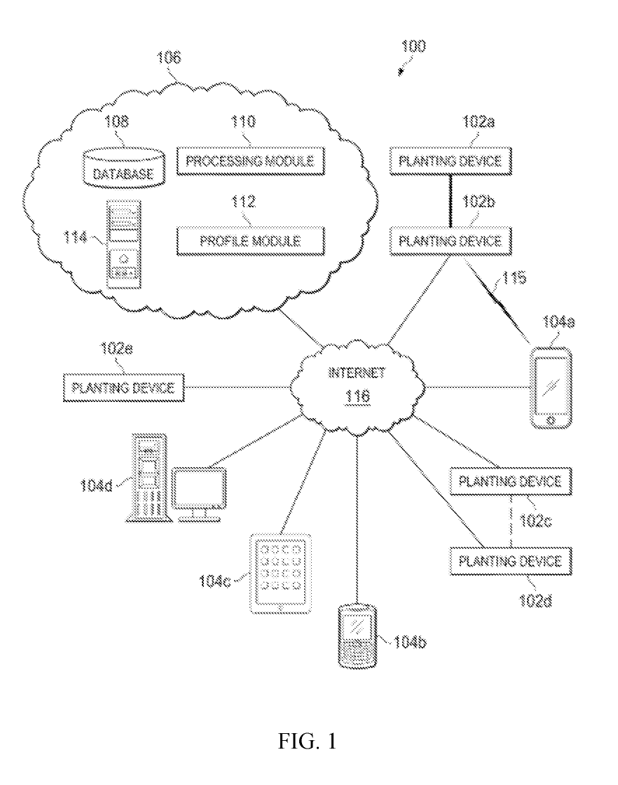

FIG. 1 is a simplified schematic diagram of a communication system (i.e., communication system 100) for managing planting devices in accordance with some embodiments of the present disclosure. In specific embodiments, communication system 100 can be provisioned for use in managing, transferring data between one or more planting devices, transferring media between the one or more planting devices, and/or otherwise managing resources for the one or more planting devices. The architecture of communication system 100 is applicable to any type of technology for facilitating growth of plants such as hydroculture (e.g., aeroponics, flood drain, wicking, nutrient film technique (NFT), irrigation systems, deep water culture (DWC), shallow water culture (SWC)), greenhouse (e.g., enclosed, semi-enclose), root zone (hydroponics, aquaponics, soil-based systems), indoor planting environments, or any other suitable environment for facilitating plant growth and/or in which data associated with plant growth is managed. Communication system 100 includes, among other things, planting devices 102a-e, endpoints 104a-d, and data center 106. Internet 116 couples the planting devices 102a-e, the endpoints 104a-d, and the data center 106.

Communication system 100 may include any number of planting devices 102a-e that are operable to establish network connectivity via various points of attachment. A planting device may include any apparatus that facilitates growth of plants. Each of the planting devices 102a-e includes hardware and software for facilitating and/or managing growth of one or more plants and/or one or more fungi. In some examples, a planting device provides physical support for one or more plants (e.g., trellises, cages, support strings, root zone media such as gravel, pebbles, sand, soil, woodchips, or other organic media), supplies (e.g., using electrical and/or mechanical systems) nutrient to the one or more plants, and facilitates control (e.g., using the electrical and/or mechanical systems) of an environment in which the one or more plants grow. Each planting device includes (or is otherwise coupled to), among other things, a plurality of sensors and a plurality of actuators. Each sensor can detect environmental data (e.g., recorded as variables) that describe environmental conditions in which a plant or fungi grows. The data may include environmental variables that describe a physical parameter of a growing environment (e.g., variables describing atmospheric, hydrologic, soil, root zone, flow of water or solution from below a root zone, or photic measures). A processing module associated with the planting device (e.g., a processing module local to the device, located at data center 106, or another location) may receive the environmental data from one or more of the plurality of sensors. Each actuator can generate an output that changes (or otherwise influences) environmental conditions in which the plant or the fungi grows. A planting device can control (e.g., actuate) the actuators and can detect a current state of the actuators (e.g., whether an actuator is on or off, current settings of the actuator). Each planting device can execute (or otherwise access) a control loop that controls environmental variables toward a specified level (e.g., a target value), which can change or oscillate over time (e.g., daily, weekly, monthly, by season of a year, by stage of the lifecycle of the plant, annually). Any of the planting devices 102a-e may receive data, e.g., from a sensor or an actuator. Each planting device may transmit, via Internet 116, the data (or a portion thereof) to the data center 106 for storage, processing, and or forwarding to other components of communication system 100.

In some embodiments, each of planting devices 102a-e measures and records variables related to plant or fungi growth (e.g., variables that describe environmental conditions in which the plant or fungi grows or variables that describe the health and growth of the plant itself), analyzes the recorded variables, and controls a growing environment based on the analysis. The planting devices 102a-e may transmit the recorded variable data to the data center. The data center may generate optimized growing plans (e.g., growth regimes) allowing farmers, growers, or gardeners to remotely monitor and track their greenhouse, indoor, irrigated, hydroponic, or aquaponic farming operations while automating their atmospheric, hydrologic, soil, and/or photic growing environments and optimizing for variables such as crop yield, produce quality, pathogen resistance, energy consumption and/or operational costs.

In addition, each planting device 102 may communicate with any of the one or more endpoints 104a-d. A planting device can directly communicate with an endpoint (e.g., without the use of an intermediate network). For example, the planting device 102b has a direct wireless data connection 116 with endpoint 104a. The planting device 102b can directly transmitting data to the endpoint 104a over the wireless data connection 115. Likewise, the endpoint 104a can directly transmit, over the wireless data connection 115, data to the planting device 102b. In other examples, the endpoint and the planting device may be coupled by a wired connection. A planting device can communicate with an endpoint over a network. For example, the planting device 102e and the endpoint 104b may communicate over the Internet 116 (e.g., using IP addresses for each device). In addition, a planting device can communicate with an endpoint via a data center. For example, and the endpoint 104d may transmit, over the Internet 116, data to the processing module 110 in the data center 106. Subsequently, the processing module 110 may transmit the data from the data center to the planting device 102c (e.g., the processing module may immediately relay the data and/or may only transmit the data based on a request received from the planting device 102c). The planting device 102e may use a similar process to transmit data to the endpoint 104d via the data center.

Communication system 100 may include any number of endpoints 104a-d. Each endpoint may be any communication device with hardware and/or software enabling communication of data over a network. The term ‘endpoint’ includes any device operable to initiate communication over a network. Exemplary devices include (but are not limited to), a computer, a tablet, a mobile phone, a router, server, a loadbalancer, a planting device, or any other network component. Each of the endpoints 104a-d may be associated with an individual, an organization, a farmer, a customer, or any end user accessing data associated with a plant, fungi, or planting device within the communication system 100. Each of the endpoints 104a-d is operable to receive one or more inputs. An endpoint may process the one or more input and/or transmit the input to another endpoint. In some case, the inputs are transmitted from the endpoint to the data center 106 (e.g., via servers 114 and/or processing module 110). The endpoints 104a-d can retrieve current levels (e.g., via servers 114) for each environmental variable measured by sensors coupled to planting devices 102a-e. Likewise, the endpoints 104a-d can retrieve a status of each actuator coupled to planting devices 102a-e. The endpoints may receive inputs that identify a growth regime to be executed by one or more of planting devices 102a-e. A growth regime includes a schedule (in time) of environmental variables across the life span of a plant or the course of a year. A growth regime may include one or more control loops each corresponding to a different environmental variable. Each environmental variable can be specified to remain constant or vary across time (based on the control loops) at any time before or during a cultivation period. The cultivation period is a period of crop growth beginning from planting until final harvest. User interaction (e.g., besides hardware setup and maintenance) with the communication can be performed using an endpoint that utilizes an application (e.g., an application executing locally on the endpoint or provided to the endpoint over an Internet connection). This application (and/or endpoint) receives input which include manipulation of actuators (e.g., turning on or off, or adjusting operational variables of actuators), adjustment of growing regimes, input event data, outcome data, harvest data, view their current environmental variables, interact with other endpoints (or corresponding users), share and view personal and public crop profiles, and perform other tasks.

The data center 106 can store data, process data, and facilitate transfer of data between the planting devices 102a-e and the endpoints 104a-d. The data center 106 includes one or more servers 114, a database 108, a processing module 110, and a profile module 112. Each of the one or more servers 114, the database 108, the processing module 110, and the profile module 112 are operably coupled to one another. The one or more servers 114 may receive data from one or more of the planting devices 102a-e and/or may receive data from one or more of the endpoints 104a-d. In addition, the one or more servers 114 may receive input data (e.g., event data, harvest data, values of environmental variables, a selection of a growth regime, modification of an existing growth regime, and the like) from any of the endpoints 104a-d. The one or more servers 114 may utilize the processing module 110 to store the inputs in databases 108 and/or transmit the inputs to any of the planting devices 102a-e. In another aspect of communication system 100, the one or more servers 114 may receive input data (e.g., harvest data, values of environmental variables, and the like) from any of the planting devices 102a-e. The one or more servers 114 may utilize the processing module 110 to store the inputs in databases 108 and/or transmit the inputs to any of the endpoints 104a-d. In yet another aspect, the one or more servers 114 may transmit (via Internet 116), to a controller in any of the planting devices 102a-e, parameters for implementing one or more control loops. Each of the one or more control loops may correspond to an environmental variable that is being sensed by a sensor on a planting device (and/or an environmental variable that is being influenced by an actuator on the planting device). In some embodiments, the data center 106 may store a crop profile for each of a plurality of plants (e.g., based on plant variety, species, genus and the like).

The one or more servers 114 may receive requests from and generate responses to (e.g., using Hypertext Transfer Protocol (HTTP), Internet Protocol (IP), or any other communications protocol) the planting devices 102a-e and/or the endpoints 104a-d. In some cases, the servers receive one or more crop profiles. The crop profile data may be stored in the database 108. The crop profile may include one or more of the following data: a growth regime, time series data for a plurality of environmental variables (e.g., measured through an entire process of, e.g., planting, sprouting, growth), event data, harvest data describing a plant harvest (e.g., weight, volume, quantity, count, quality, and the like), or other data related to growth and/or harvest of a plant. Regardless of a source of data, the one or more servers 114 may store at least a portion of the data the database 108.

The database 108 may include one or more of a relational database, a hierarchical database, a time series database, or any other model of database usable to store data related to a planting device and/or facilitating plant growth. The database may be implemented in a hardware including, e.g., hard disk drive (HDD), magnetic disks, solid-state disk (SSD), random access memory (RAM), or any other memory element.

The processing module 110 may process data received (either directly or via servers 114) from the planting devices 102a-e and/or the endpoints 104a-d. The processing module 110 can synthesize data from a first subset of planting devices to improve harvest yields, harvest quality, or other metric for a second subset of planting devices (e.g., where the subsets are mutually exclusive). In a particular example, the processing module 110 receives from a plurality of planting devices 102a-e and/or a plurality of endpoints 104a-d crop profiles for a plant; the processing module 110 analyzes (e.g., using one or more optimization algorithms) a plurality of crop profiles for the plant along with desired outcomes (as defined in as metric and/or user selections using an endpoint); and generates a growth regime for the plant based on the analysis. Subsequent to generating the growth regime for the plant, the processing module 110 may store the growth regime in the profile module 112. The profile module 112 may store data related to the generation and storage of crop profiles and/or growth regimes. In one aspect, profile module 112 stores crop profiles and/or growth regimes. The processing module 110 may retrieve the crop profiles and/or growth regimes from the profile module 112 (e.g., for transmission to a planting device 102). Further discussion of generating growth regimes is provided with respect to FIG. 14 and/or FIG. 15.

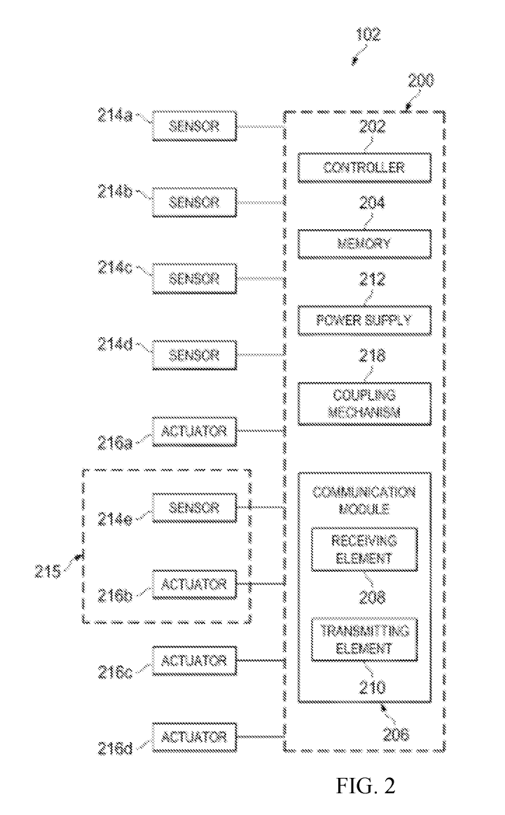

FIG. 2 is a simplified diagram of a planting device 102 according to some embodiments of the present disclosure. The diagram illustrates, among other things, a logical view of the planting device. The planting device 102 includes hardware and executable code for facilitating plant growth by, e.g., monitoring environmental variables and system variables pertinent to plant growth in a planting device; tracking trends in recorded data for one or more variables (environmental and/or system); activating (or deactivating) a planting device; actuating an actuator that controls (or influences) an environment in which a plant grows within the planting device; setting control regimes for one or more actuators (or other environmental control devices); generating a crop profile for a plant growing in the planting device; executing a growth regime or crop profile (e.g., generated based on optimization algorithms). Such facilitation of plant growth may be implemented in an application (e.g., executing a local application on the planting device; or accessing an application provided over the Internet, such as a web application). In particular, the planting device 102 includes a processing module 200, a plurality of sensors 214a-e, and a plurality of actuators 216a-d. The processing module 200 includes a controller 202, a memory 204, a power supply 212, a communication module 206, and a coupling mechanism 218. In some embodiments, the processing module is a circuit board to which the controller 202, the memory 204, the power supply 212, and the communication module 206 are coupled. The circuit board can facilitate transfer of electrical signals (e.g., power, data, and the like) between the components (i.e., 202, 204, 206, 212). The communication module 206 includes a receiving element 208 and a transmitting element 210. The planting device 102 of FIG. 2 is an example implementation of one or more of planting devices 102a-e of FIG. 1.

In a broad sense, the planting device 102 includes a set of electrically connected nodes (e.g., a network of nodes) with specific functions for use in an agricultural operation and/or facilitating growth of the one or more plants in the planting device. Each node may include a plurality of components that enable functions for facilitating plant growth. For example, each node may include one or more circuits that are specific to the function of the node (e.g., based a specific executing code for the function). Each node can include a microcontroller. The microcontroller receives commands or data requests from the controller 202. In addition, the microcontroller can initiate the one or more actions (e.g., retrieving sensor readings and/or turning an actuator on/off). The microcontroller generates (or processes) data associated with the nodes (e.g., sensor readings or actuator status (on/off)). When data are generated, microcontroller may encapsulate the data in a data object (e.g., a digital packet) and transmit the data object to the controller 202. In addition, a node may include a power conversion module to convert power from in input voltage (e.g., received from power supply 212) to another voltage. For example, the power conversion may receive 24v AC input power from power supply 212 and convert it to DC voltages necessary for the microcontroller, sensors, actuators, light-emitting diodes, or other controllable peripherals included in the node. Nodes may have one or more connectors. The connectors enable the sensors to be coupled (e.g., wired or linked) to on another and/or to the processing module 200. For example, a cable may couple connectors on each of a pair of neighboring nodes to form a hardware network. The connectors may include any one or more of: a 4-pin electrical receptacle, a 4-wire connector, an 8-wire connectors, male or female connectors, a Universal Serial Bus (USB) connector, and/or any other connectors for transferring data between devices. Each node may include a mounting interface (e.g., two threaded holes) enabling mounting of the node to a planar surface (e.g., a wall), a pipe, a reservoir brim, rafters, glass, or other surface of the planting device. Fasteners (e.g., mounting brackets, screw, nut and bolt assemblies, suction cups, glue, and the like) may correspond to and couple with the mounting interface to mount the node to the surface.

Nodes are inclusive of at least the following types of nodes: nodes that sense variables (i.e., sensors such as sensors 214a-e) and nodes that actuate devices and, thereby, adjust variables (i.e., actuators such as actuators 216a-d). Some nodes are hybrids and perform both sensing and actuation (e.g., node 215). The nodes may sense and/or control several aspects of an environment within the planting device. For example, the nodes may control one or more of a photic environment within the planting device, a root zone environment within the planting device, and/or a canopy environment within the planting device. The photic environment may be defined by environmental variables including (but not limited to), e.g., light intensity (e.g., a lux value, or a photosynthetically active radiation (PAR) value in μmol photons m̂−2*ŝ−1), light angle, color of spectrum (e.g., ratio or percentage of light in a particular, color temperature in Kelvin (K), or other measures), or any other measure (directly or indirectly) corresponding to lighting conditions.

A root zone environment may be defined by environmental variables relating to conditions in which nutrients are provided to the roots of a plant via an aqueous media (including, but not limited to, e.g., water temperature, pH of the aqueous media, dissolved oxygen, level of nitrites in the aqueous media, a level of nitrates in the aqueous media, level of ammonia in the aqueous media, and the like). The root zone environment may include nodes that irrigate and/or provide fertilizer or nutrients to the roots of the plant in an aqueous media. The aqueous media may be only water, a nutrient solution in water, soil containing an amount of water (e.g., less than 10% water by volume, about 50% water by volume, greater than 50% water by volume, greater than 90% water by volume (i.e., mostly water with few soil solids)), or a homogenous mixture of water (which may include nutrients) and other solid media. The canopy environment may be defined by environmental variables relating to air surrounding a plant (including, but not limited to, e.g., air temperature, humidity, the level of oxygen in the air or other, or other variables). The canopy environment may include nodes that control actuators to preventing the buildup of heat, humidity, and oxygen in the plant canopy and improving the home air quality proximate the plant growing therein.

A sensor (each of the plurality of sensors 214a-e in FIG. 2) measures a value of a variable (e.g., at defined interval or continuously). The sensor may store the most recent value on the onboard microcontroller. The sensor transmits the most recent value when requested by the controller 202. Due to variance in sensor readings, each sensor node may average many data points over a period of time (1-10 seconds) and store and/or transmit an averaged value to the controller 202. If the sensor node detects a large variance in data, it can transmit a signal to the controller 202 to generate an alert (e.g., for display in a graphical user interface). The alert may identify that a specific sensor may need to be recalibrated or replaced. In the example of planting device 102, the sensors measure environmental variables and/or system variables pertinent to plant growth in the planting device. For example, each of the plurality of sensors 214a-e can measure (e.g., sense or detect values of) environmental variables within the planting device 102. The environmental variables may include atmospheric measures, hydrologic measures, soil, radiative measures (e.g., light), photic measures, air temperature, water temperature, water level, humidity, power consumption, light, pH, EC, flow, proximity, or any other parameters or measurable conditions affecting the environment within the planting device. Other exemplary sensor nodes include hydrologic sensor nodes, water temperature sensors, water temperature sensor, atmospheric sensor nodes, humidity and air temperature sensor nodes, light sensor nodes, soil sensor, and/or other sensors. A hydrologic sensor node measures multiple hydrologic variables including: water temperature, pH of the water, electrical conductivity of the water, dissolved oxygen in the water, and oxidation reduction potential (ORP) of the water.

As an example, a water level sensor can measure the depth of water in a receptacle. Through transpiration and evaporation, the volume of water in a planting device will decrease over time. A water level sensor in a receptacle can monitor the rate at which water is lost from the planting device, both into the plants and the air. The rate is an indicator of plant growth and environmental stability. Monitoring water level is also essential because adding water to the planting device is an important maintenance procedure for maintaining health plants. An atmospheric sensor node can measure one or more atmospheric variables. For example, an atmospheric sensor may measure, e.g., air temperature, humidity, carbon dioxide concentration, ammonia, methane, oxygen, and or other atmospheric variables. A light sensor node can measure one or more photic variables sensor. A soil sensor can measure any one or more of measures soil moisture, temperature, pH, electrical conductivity, methane, oxygen, and/or nitrate (i.e., with respect to the soil).

An actuator (e.g., each of the plurality of actuators 216a-d in FIG. 2) is inclusive of any electrical component that may be electrically or mechanically actuated. Exemplary actuators include (but are not limited to) a fan, a pump (e.g., water pump, air pump, etc.), an spray nozzle (e.g., an air-actuated spray nozzle, an electrically-actuated spray nozzle, a hydraulic spray nozzle, air atomizing nozzles, and the like), a motor, a servomotor, a rotary actuator, a feeder device (e.g., an animal feeding device, a fish feeding device), a valve (e.g., a liquid dispensing valve, a micro dispensing valve, a drop-dispensing valve (e.g., dispensing about one microliter, or about 0.05 milliliters of a liquid)), an electric light source (e.g., light emitting diode, a florescent lamp, or any other electrical lamp), a heater (e.g., a water heater, an air heater, and the like), a cooling device (e.g., a heat exchanger, an air conditioner), an aerator (e.g., a water aerator), a doser (e.g., an electrically-actuated apparatus adding one or more chemicals to liquid), electrical outlets, fish feeders, and/or LED arrays (e.g., LED light source). Some actuator nodes may include more than one electrical component (e.g., more than one motor, fan, light, and the like). Power may be supplied to and or terminated from each electrical component independent from other electrical components.

A doser may include one or more peristaltic pumps operable to dose specific volumes of acids or bases to adjust pH, fertilizer to maintain ideal EC levels, or other liquid nutrients to combat nutrient deficiencies. In a particular example, intake and output tubes extend outside an enclosure of the doser and run from a solution (i.e. a solution to be added to the system) through the internal peristaltic pumps into a receptacle of the planting device. An exemplary LED array comprises a single circuit board with a plurality (e.g., 5) separate banks of LEDs of different wavelengths (e.g., infrared, red, green, blue, and ultraviolet LEDS) distributed evenly across the array. Pulse-width modulation (PWM) control adjusts the relative brightness of each bank of LEDs to mimic sunlight spectrum and intensity at different times of day or year, different latitudes, or various levels of cloud cover. The LED array can complete a feedback loop for spectrum and luminosity when combined with the photic sensor node.

Nodes (e.g., sensors 214a-e, actuators 216a-d, node 215 in FIG. 2) may be added to or removed from the planting device 102 (e.g., while the planting device is operating). The processing module 200 detects that a node has been coupled thereto. For example, when a node is initially coupled to the processing module 200, the node may transmit a digital packet (e.g., containing an identifier of the node, a serial number of the node, an identifier of the planting device in which the node is located, an identifier of a farm in which the planting device is located, a node type, and/or any other data identifying the node) to the processing module. Upon receiving the digital packet, the processing module 200 may transmit a portion of contents of the digital packet to a data center (e.g., to register the node in a backend database and/or to store an associated between the node and the planting device). The processing module 200 detects that a node has been decoupled therefrom. Each node may broadcast a repeated packet (e.g., a heartbeat) announcing one or more identifiers identifying the node. For example, the processing module 200 can detect that a measurement (or heartbeat) has not been received from a sensor within a threshold period of time (e.g., based on an expected sampling frequency of the sensor, a number of missed samples from a sensor, and the like). When it is determined that the measurement has not been received in the threshold period of time, the processing module 200 can determine that the sensor is decoupled from the processing module. Other approaches of detecting coupling or decoupling of sensors and/or actuators are equally applicable to embodiments of the present disclosure.

In planting device 102 of FIG. 2, the processing module 200 includes the controller 202, the memory 204, the power supply 212, the communication module 206, and the coupling mechanism 218. In some embodiments, the processing module is a circuit board to which the controller 202, the memory 204, the power supply 212, the communication module 206, and the coupling mechanism 218 are coupled. The circuit board can facilitate transfer of electrical signals (e.g., power, data, and the like) between the components (i.e., 202, 204, 206, 212, 214, 215, 216, and 218). The controller 202 executes main operations of the planting device 102. The controller 202 is operable to communicate with any of sensors 214a-e, actuators 216a-d, the memory 204, power supply 212, and communication module 206. Further discussion of the controller is provided through the present disclosure. The memory 204 is hardware for storing data. Such hardware may include any one or more of hard disk drive (HDD), magnetic disks, solid-state disk (SSD), random access memory (RAM), or any other hardware operable to store data. The power supply 212 can include a plurality of power sources (e.g., at different voltages) for supplying power to each of sensors 214, actuators 216, the controller 202, the memory 204, the communication module 206, and the coupling mechanism 218. Each of the aforementioned components can receive power from the power supply 212. The coupling mechanism 218 is hardware for coupling the planting device 102 to at least one other planting device. The at least one other planting device may include components similar to those in planting device 102 (e.g., at least one plant, at least one actuator, etc.). The coupling mechanism 218 may be a data connection port such as a USB, a serial port, or other electrical communication port enabling transfer of data between two such planting devices. In operation, coupling mechanism 218 is operable to receive attachment of the at least one other planting device (e.g., using a connector corresponding to the port). While the coupling mechanism 218 is attached to the other planting device, the controller 202 may control transmission of one or more resources to both the planting device and the other planting device. In a particular embodiment, the controller 202 may utilize any one of the actuators 216a-d and an actuator coupled to the other device to control the transmission of the one or more resources. The communication module 206 includes a receiving element 208 and a transmitting element 210. The receiving element 208 is operable to receive communications over a network. The transmitting element 210 is operable to transmit communications over the network. In some examples, the communication module 206 is a router, wireless receiver, or any devices that can receive, transmit, or otherwise facilitate transferring signals over a network and between two or more devices.

The processing module 200 operates as an intermediary hardware between the nodes and a network. Within the processing module, the controller 202 is coupled to communication module 206. The nodes may be coupled (directly or indirectly) to ports (or virtual ports) on the processing module 200. The communication module 206 may receive (e.g., from a data center and using receiving element 208) information associated with a control loop (e.g., parameters or inputs to the control loop) and transmit the information to the controller 202. The controller 202 may receive the information and store it in memory 204. The controller 202 may store such control loop information for each of a plurality of variables (e.g., system variable and or environmental variables). In some embodiments, the controller 202 implements control loops for one or more variables (e.g., a negative feedback control loop), transmits commands and requests (e.g., for implementing a control loop) to the nodes in the network, and/or receives data (e.g., values of environmental variables, node administration messages, data identifying the node, and the like) from each node.

In an exemplary operation of the planting device 102 of FIG. 2, each sensor may transmit data (e.g., values) corresponding to one or more environmental variables to the controller 202. When the controller 202 receives the data from the sensor, the controller 202 can add a timestamp corresponding to the time at which the data is received from the sensor. The timestamp may include any one or more of: a date, a time value in Coordinated Universal Time (UTC), a time value and corresponding time zone, and/or any other electronic encoding of a format for recording and transmitting timestamps. The controller 202 transmits this time-stamped sensor data via a network (e.g., Internet 116) to a data center (e.g., data center 106, or any other data center capable of storing and processing such data). In some examples, the controller immediately transmits the time-stamped sensor data to the data center. In other examples, the controller stores time-stamped sensor data corresponding to a period of time (e.g., three hours, two hours, or any other appropriate time window) in the memory 204. In such examples, the controller may only transmit the time-stamped sensor data at a frequency corresponding the period of time (e.g., every three hours, every two hours, etc.). In still further examples, the controller may store the time-stamped sensor data (corresponding to the time period) and immediately transmits the time-stamped sensor data to the data center. Such an implementation may allow the planting device to continue recording data after a loss in network connectivity, send the data after network connectivity is regained, and, thereby improve the resiliency of the system with respect to network connectivity.

The controller 202 enables transmission of commands from a data center (e.g., data center 106) to the nodes. The controller 202 is operable to control, among other things, any of the sensors 214a-e, the actuators 216a-d, the memory 204, the power supply 212, and the communication module 206. The controller 202 receives commands from the data center (and/or servers therein). The controller 202 identifies a destination node for the commands (e.g., based on data contained in the command and/or metadata associated with the command). Ultimately, the controller 202 transmits the commands to the identified node. Such commands may include requests for updated variable values from sensing nodes and/or instructions for adjusting variables via actuation nodes. The controller 202 may also receive parameters for control loops for each variable being both sensed and actuated. The controller 202 may execute code that defines procedures of the control loop. Based on the procedures, the controller 202 transmits commands to the actuation nodes that adjust an output of the actuator (e.g., where the output has a direct or indirect influence on the variable). The parameters for control loops may be stored on the memory 204 (which is locally accessible by the controller). Such local storage allows the planting device to remain operational even when network connectivity is lost and, thereby, improves resiliency to network connectivity failures.

The controller 202 may execute one or more control loops. Executing a control loop (e.g., by the controller 202) may include: detecting, from a sensor, a value of a variable; comparing the value of the variable to a target value of the variable (e.g., to determine a difference value); and actuating an actuator based on the comparing. The actuator may control (or influence) an environment (i.e., as measured by sensors detecting values of environmental variables) in which a plant grows within the planting device. In some cases, the actuator may be se to produce an output value that is a predetermined fraction (or multiple) of the target value (e.g., to gradually increase (or decrease) the variable toward the target value). In some cases, the actuator may be actuated being set to a value that is based on the difference value (e.g., based on a table that includes a correspondence between a target value and an output value (for the actuator) required to reach the output from the (current) value of the variable).

A control loop includes instructions for actuating one or more actuators based on one or more variables (e.g., measured by a sensor). Each variable can correspond to a sensor and/or an actuator. For example, the sensor may measure a value of the variable and the actuator may produce output that influences the measured value of the variable. Thus, value of the variable can (in effect) be influenced based on controlling the actuator using a control loop. The control loop may identify a target value for a variable and a tolerance range for the variable. Instructions in the control loop may specify determining an output value for an actuator (e.g., based on the output value corresponding to an expected change in the measured value) and setting the actuator to operate at the output value to adjust the value of the variable. Feedback (e.g., as to an effect of the output of the actuator) comes from the value of the as measured by the corresponding sensor(s) and/or rate of change of the measured variable over a duration of time (e.g., a most recent 5-60 minutes, or any other time period relative to a current time). The control loop may instruct the controller to retrieve such feedback (e.g., sensor measurements, calculate rate of change data from the sensor measurements, and or other data) from the sensors. The tolerance range may identify a threshold on either side of the target value (e.g., may be a value that is added to and subtracted from the target value to sets an upper bound and a lower bound respectively). In some examples, a control loop instructs a controller to determine whether a measured value of the variable is within the upper bound and the lower bound. If it is determined that the measured value of the variable is within the v (e.g., and/or equal to either of the upper bound and the lower bound) the controller may deactivate the actuator (e.g., to turn the actuator off, or cut power to the actuator). If it is determined that the measured value of the variable is not within the upper bound and the lower bound the controller may activate the actuator (e.g., to turn the actuator on, or transmit power to the actuator). In some examples, the target value, the upper bound, and the lower bound are set based on a growth regime. In some examples, the target value, the upper bound, and the lower bound are set based on input received by an endpoint (e.g., user input values). In either case, these three values are transmitted to a controller (e.g., controller 202), which executes the control loops.

While a plant (or set of plants) is growing, the sensors measure environmental variables (e.g., and thereby generate environmental data) and the controller determines whether the environmental variables satisfy a control loop (e.g., target our bounds defined in the control loop). The control loop may be identified in a growth regime utilized by the controller. A growth regime may define a plurality of target values corresponding to a plurality of environmental variables. The control loop can control an output of an actuator based on at least one of the plurality of target values in the growth regime. If a variable is outside of the tolerance range, the actuator for that variable is triggered to adjust the variable to match the target value (or adjust the variable to lie within the tolerance rage). If there is no actuator for the variable that is outside of the tolerance range, directions for manually adjusting the variable may be transmitted to an endpoint (e.g., via a text message, a SMS message, email, or a notification in an application). During a time in which a growth regime is being implemented (e.g., during the cultivation period), an endpoint associated with the planting device may receive an input including event data describing one or more plants in the planting device. Event data is inclusive of data that identifies deviations from a growth regime and/or conditions that are undefined by the growth regime (e.g., a pathogen infecting the one or more plants, a pest affecting the one or more plants, a nutrient deficiency, crop measurements, and/or health indicators). After each crop is harvested, the user can input outcome or harvest data. Harvest data is inclusive of dependent variables related to yield (weight, volume, or quantity) or produce quality (color, taste, nutrition, etc.). Thus, an endpoint may receive harvest data including a measure of a harvest of a crop, an average size of a fruit or vegetable harvested by the crop. At the end of a cultivation period, a crop profile is generated from the actual and initial growing regime data, event data, the measured environmental variables (e.g., time series including the entire duration of the cultivation period), and the outcome data. These crop profiles can be compiled across one or more planting devices to generate a target crop profile (and or growth regime) given a set of desired outcomes.

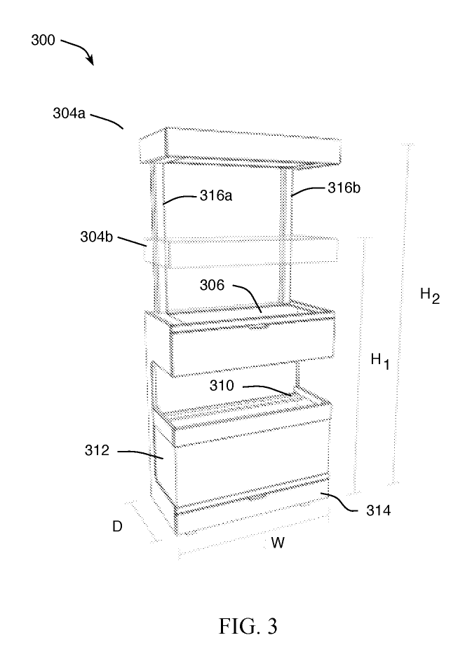

FIG. 3 is a simplified diagram of a planting device 300 according to some embodiments of the present disclosure. The planting device 300 has a width (W) and a depth (D). The planting device includes a lighting module 304. The lighting module 304 is coupled to support bars 316a and 316b. The support bars are coupled to a body of the device 300 by an attachment mechanism. In this example, the attachment mechanism is a bracket attaching that wraps the support bars 316a and 316b. The lighting module is moveable between a first position 304a (at a height of H2) and a second position 304b (at a height of H1) based, at least in part on movement of the support bars 316a and 316b with respect to the attachment mechanism (e.g., the attachment mechanism is stationary and the bars 316 slide, linearly, with respect to the attachment mechanism). In this example, the height H2 is greater than the height H1. The device 300 also includes receptacles 306 and 312. The receptacle 306 is also a growing bed. The receptacle 312 has a small goring bed 310 suspended above it. Each growing bed is configured to facilitate growth of plants. In this example, the growing bed 306 is enclosed at least in part by door 308. In FIG. 3, the door 308 is shown in the closed position. However, the doors operable between the closed position and an open position (e.g., where in the open position the door rotates about bottom edge of the door to become a working surface for a user). The growing bed 310 is supported at least in part by receptacle 312 (e.g., a tank for supporting growth of aquatic organisms such as, e.g., fish). The receptacle 312 is partially enclosed by door 314. In FIG. 3, the door 314 is shown in the closed position. However, the door is operable between the closed position and an open position (e.g., where in the open position the door rotates about bottom edge of the door to become a working surface for a user).

An attachment mechanism (e.g., coupling the body of the device 300 to the support bars) comprises a bracket made of a rigid material and a solid material that fits within internal channels of support bar and provides an interface (e.g., relatively low friction) for slidably moving each bar with respect to the bracket, which may remain stationary. A bottom portion of the bracket is supported by a lifting element. In some examples the lifting element is a torsional spring that supports the bottom end of the bars 316 so that it comes to arrest in whatever position a user may place it in (e.g., holds the bars 316 at rest regardless of whether the user places it at a first position or at a second position). For example, a torsional spring may include a rotational element and a planar member both of which are attached to and end of a bar (e.g., the bars 3176) an attachment mechanism. The rotational element is fixed to a body of the planting device at its center point and can rotate about the center point. Thus, as the bar moves up or down (with respect to the rotational element), the planar element unwraps or wraps around the rotational element and provides a lifting force to the supported end of the bar.

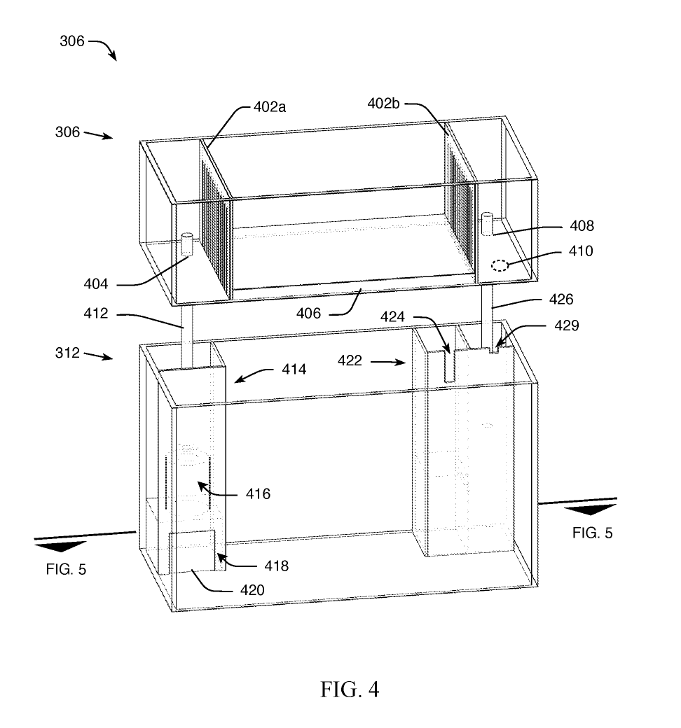

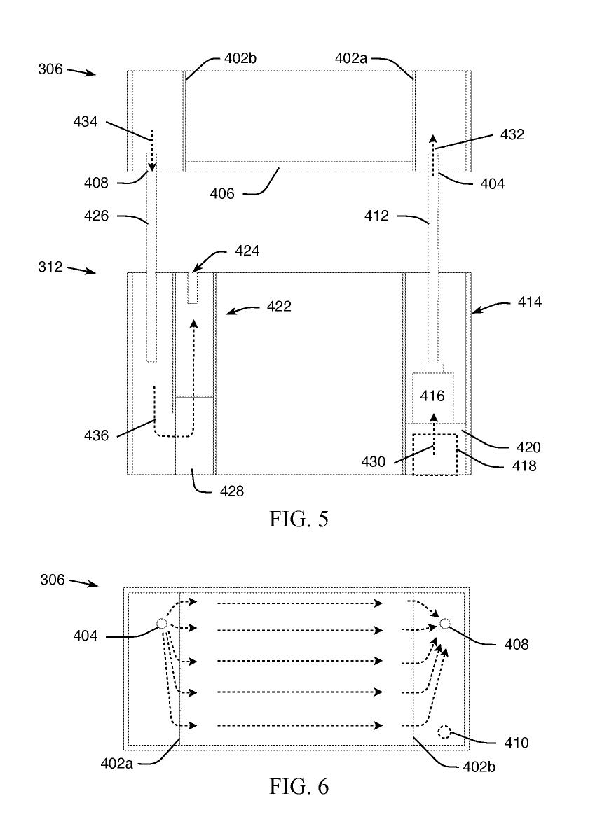

The planting device 300 includes a system for filtering and distributing fluid throughout the planting device. FIG. 4 is a simplified three-dimensional diagram of a system for filtering and distributing fluid in the planting device of FIG. 3. FIG. 5 is a rear view of the system of FIG. 4. The viewpoint of FIG. 5 is generally indicated by the arrows labeled “FIG. 5” in FIG. 4. FIG. 6 is a top view of the system of FIG. 4. The operation of such a system is described with simultaneous reference made to FIGS. 4, 5, and 6. The system includes the receptacles 306 and 312. The receptacle 312 comprises a cavity 414, a U-shaped channel 422, a pump 416, and two filters (e.g., 416 and another in the U-shaped channel 422). The receptacle 306 comprises two or more apertures (i.e., 404, 408, and 410) for intake and output of fluid, perforated barriers 402a and 402, a filter 406. The pump 416 pumps fluid from the receptacle 312 up to the receptacle 306 via the filter 420. The fluid enters the aperture 404 and is distributed across the width of the receptacle by the perforated barriers 402a and 402. Each barrier partially obstructs fluid flow between the aperture 404 and the apertures 408 and/or 401. In addition, each barrier include a plurality of perforations located along a width of the barrier; each perforation allows fluid to flow through the barrier. The perforated barriers between input and output apertures in the receptacle 306 splits a single fluid flow into several pathways located parallel to the fluid flow direction, as generally indicated by the dashed arrows in FIG. 6. Such barriers disrupt any fluid from taking a direct path between the input and output apertures and facilitate distributing the fluid across a wider area in the receptacle based on the placement of the perforations in the barriers. Because the receptacle 306 is located at a higher vertical elevation than the receptacle 312, gravity drains the fluid from the receptacle 306 back to the receptacle 312. The water passes through several filters as it is circulated through the planting device (e.g., filter 420, 406, and the filter 428 in the U-shaped channel). The filtration mechanisms being located at various locations throughout the planting device enables filtration to continue even if any one location is compromised. Additional details of the of fluid circulation and filtration are further described below.

The receptacle 312 is a receptacle in which one or more aquatic organisms live. The aquatic organisms can include fish, aquatic plants, or any other organism that survives and thrives in an aquatic environment. The filter 420 advantageously protects the aquatic organisms from the pump and protects the pump from being clogged by aquatic organisms. The aquatic organism may excrete biological waste into the fluid. Bacteria can break down (e.g., consume) the biological waste to produce (e.g., excrete) ammonia, nitrites and/or nitrates. Because the fluid is circulated through each of the each of the receptacles, plants growing in other receptacles in the planting device receive the ammonia, nitrites and/or nitrates. In turn, the ammonia, nitrites and/or nitrates are nutrients that can be absorbed by the one or more plants (e.g., in receptacle 306) from the aqueous media. In general, an aqueous media may include chemicals, bacteria, nutrients, etc. consistent with principles of hydroponics, ecoponics and/or aquaponics. In this example, the tank is made of a rigid, clear material. One some examples, such a tank may be made of glass, transparent plastic (e.g., Plexiglas™), or any rigid, clear (or translucent) material.

Returning to fluid flow between the receptacles 312 and 306, the pump 416 pumps fluid from the receptacle 312 through the filter 420 to the aperture 404 of the receptacle 306. The cavity 414 (in receptacle 312) includes an opening 418 that allows fluid to enter the cavity from the receptacle 312. The opening 418 in the cavity 414 is obstructed by the filter 420. The filter 420 is porous and allows water to pass through. In this example, the cavity 414 is defined, in part, by the walls of the receptacle 312. In other implementations, the cavity may be a free standing element (e.g., a pump cage or box) located completely within the receptacle. The cavity 414 and the filter 420 enclose a pump 416. The pump is operable to draw fluid from the receptacle 312 into the cavity 414 through the opening 418. Because the filter 420 obstructs the opening, the fluid passes through pores of the filter 420 (as generally indicated by 430 of FIG. 5) while debris and other particles are filtered from the water and may remain trapped in the filter. The pump outputs the filtered fluid up through the conduit 412. The conduit 412 is coupled to the aperture 404, through which fluid is delivered from the pump 416 into the receptacle 306 (as generally indicated by 432 of FIG. 5).

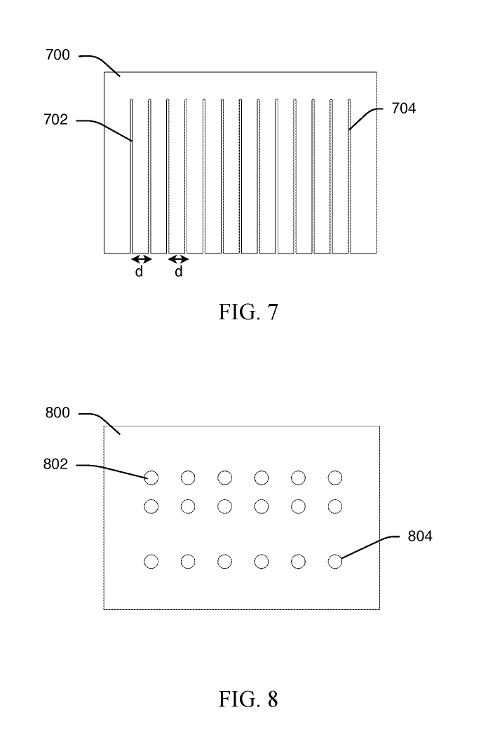

The fluid delivered from receptacle 312 to receptacle 306 is rich in nutrients produced from the biological waste of aquatic organisms in the receptacle 312. The receptacle 306 is a growing bed for growing plants in aqueous media and may also contain solid media. Fluid is received in the receptacle 306 from the aperture 404 (e.g., an intake aperture). The fluid is under pressure from the pump and, therefore, does not move back into the conduit. In some examples, the pressure is used supply water to a hose. For example, a flexible hose can be coupled to the aperture 404 to dispense fluid (under pressure) throughout the receptacle 306 and to dispose water from the system. As the water enters the receptacle 306, the barrier 402a splits the single water flow into several discrete channels, as illustrated in FIG. 6. The barrier 402a partially obstruct fluid flow between the aperture 404 and the aperture 408. The barrier 402a includes a plurality of perforations located along its width of the barrier. Each of the perforations allows fluid to flow through the barrier 402a. In this example, the perforations are vertical slots placed at a regular spacing relative to one another. The barrier 402b is similar to the barrier 402a. The fluid flows from the barrier 402a to the barrier 402b. As the fluid exits the barrier 402b, it drains by gravity into a stand pipe in the aperture 408. In this example, each of the barriers are linear and are placed along opposing edges of the receptacle 306 (e.g., each barrier is linear and is located such that a long dimension of the barrier is relatively parallel to a side edge of the receptacle). However, the present disclosure is not limited to such embodiments. For example, a barrier can be placed at an angle (e.g., 45° angle) with respect to two adjacent edges of the receptacle 306. In addition, FIGS. 7 and 8 illustrate example barriers for growing beds according to some embodiments of the present disclosure. In FIG. 7, the barrier 700 includes vertical linear slots (e.g., 792 and 704). Each of the vertical linear slots is separated by a distance (labeled “d”) relative to adjacent slots. In FIG. 8, the barrier 800 includes vertically oriented sets of circular perforations (e.g., 804 and 804) placed at regular intervals along the width of the barrier. However, each of the vertically oriented sets of circular perforations may have non-regular spacing with respect to other circular perforations in the set (i.e., the vertical spacing between the perforations in a set may not be at regular intervals). Such irregular vertical spacing may help facilitate more or less flow at different elevations in the water (e.g., to encourage more fluid flow near an elevation where roots are present in the fluid).

Fluid enters the receptacle 306 through the aperture 404 and drains from the receptacle 306 through the either aperture 408 or 410 to a filter in the receptacle 312. When both apertures 408 and 410 are used, one aperture can serve as overflow protection in case the other is clogged. For example, the overflow aperture may be coupled to a stand pipe. In the example of FIG. 4, the aperture 404 is coupled to a stand pipe that is higher in elevation than the aperture 410. Under normal operation, the fluid would flow out of the aperture 410 into the conduit 426. If the aperture 410 gets clogged, the fluid will rise to the level of the stand pipe and overflow into the stand pipe couple to aperture 404 and into the conduit 426. The conduit 426 delivers the fluid into the U-shaped channel 422 in the receptacle 312.

The fluid enters the U-shaped channel 422 in the receptacle 312 via the conduit 426 (as generally indicated by 434 of FIG. 5). The U-shaped channel 422 includes a first end and a second end. The conduit 426 is proximate the first end of the U-shaped channel 422. The first end of the U-shaped channel 422 includes a notch 429 to facilitate fluid overflow into the first receptacle. The second end of the U-shaped channel 422 includes a deep notch 424 to facilitate regular fluid flow into the first receptacle. As illustrated in FIG. 5, the filter 428 is located between the first end and the second end of the U-shaped channel 422. In regular operation, all fluid received at the first end of the U-shaped channel 422 traverses the bend in the U-shaped channel 422 (as generally indicated by 436 in FIG. 5), passes through the filter 428 and flows over the deep notch 424 in the second end back into the receptacle 312. However, if the deep notch 424 is obstructed or if the filter 428 is clogged and blocks the U-shaped channel, the water can overflow the notch 429 into the receptacle 312. The fluid can then be continually recirculated throughout the system by being pumped back up to the receptacle 306 and flow by gravity back into receptacle 312.

As an alternative the cavity 414, a pump cage can facilitate filtering fluid prior to entering the pump 416. The cage 900 includes a body defining a cavity. The body may include one or more perforations (e.g., openings or slots). One or more filter media blocks (e.g., filters) are located within an interior cavity of the body. The cage may be partially submerged in water while leaving the top end of the cage slightly above the surface of the water. In an example application, the cage may be submerged in a fish tank. In such an example, a top in of the cage may remain above the water surface while a bottom end of the cage is pushed into a granular media (e.g., rocks, sand, etc.) in the bottom of the fish tank (i.e., under water). When the pump is activated and draws water into itself the only pathway for water to enter is through the bottom of the pump cage thereby providing filtration of the water through the slots, the granular media, and through the filter media. The. In operation, a pump may be placed into the opening in the top end of the body. As the pump draws water, the water is first drawn through an opening (or other perforations), and then through the porous media before reaching the pump and thereby pre-filters the water before reaching the pump (e.g., potentially extending the life of the pump and/or facilitating bacteria in the filter media to consume elements present in water).

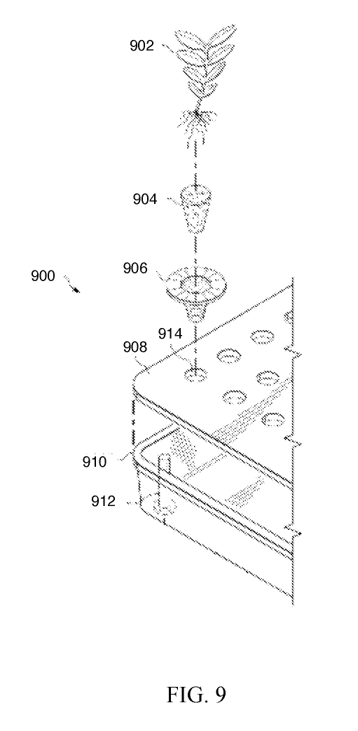

FIG. 9 is simplified three-dimensional exploded diagram of some components of a receptacle for growing plants (i.e., a growing bed) in accordance with some embodiments of the present disclosure. System 900 include a plant 902, a seed plug 904, a coir nest 906, a nest tray 908, a receptacle 910, and a stand pipe 912. The receptacle 910 is a growing bed for growing plants in aqueous media. Initially, the seed plug 904 may be placed into the coir nest 906 and, together, they are inserted into the opening 914 in the nest tray 908. The sets tray supports the seed plug 904 and the coir nest 906 suspended, at least, partially submerged in the aqueous media. As seeds in the seed plug germinate and sprout into the plant 1302; roots of the plant 1302 take hold in the coir nest 1306 and may extend into the aqueous media contained below the coir nest. The aqueous media within the receptacle 1310 drains over a top edge of the stand pipe (e.g., to maintain a depth of aqueous media approximately equal to the height of the top of the stand pipe relative to the bottom of the receptacle) and through the bulkhead 1314 into the drain 1316. The drain pipe 1316 may drain into another receptacle (e.g., as discussed with respect to any of FIGS. 3, 4, 5, and/or 6). In some examples, the receptacle 306 (of FIGS. 4, 5, 5, and 6) is a grow bed and is implemented according to the details of system 900.

In the example of FIG. 9, plants are placed into a fluid (e.g., seeds, seedlings are placed in an aqueous solution) in which they grow for a period of time. More mature plants may be placed into solid media such as stones, wood chips, moss, other solid growing media, or other non-aqueous media may be added to such growth beds (e.g., creating a homogenous mixture of the aqueous media and non-aqueous media) to facilitate growth of particular plant. Solid media, for example, can facilitate growth by creating a set of voids (between the individual solids) in which a plant can grow roots (i.e., creating a root zone).

Note that with the examples provided herein, interaction may be described in terms of a specific number of (e.g., two, three, or more) devices and/or endpoints. However, this has been done for purposes of clarity and example only. In certain cases, it may be easier to describe one or more of the functionalities of a given set of flows by only referencing a limited number of computing devices. Moreover, facilitating plant growth, transferring data related to plant growth, and/or transferring media in a planting device according to one or more embodiments of the present specification are readily scalable and can be implemented across a large number of components, as well as more complicated/sophisticated arrangements and configurations. Accordingly, the examples provided should not limit the scope or inhibit the broad teachings of the present disclosure as potentially applied to a myriad of other architectures. For example, each of the filters may include a plurality of different filters (e.g., one or more filter media blocks), each having a different pore size for filtering out particles of different sizes.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A system for filtering and distributing fluid in a planting device, the system comprising:
a first receptacle comprising a first filter and a second filter;
a second receptacle comprising first aperture and a second aperture, wherein fluid can enter the second receptacle through the first aperture and drain from the second receptacle through the second aperture to the second filter in the first receptacle;
a pump configured to pump fluid from the first receptacle through the first filter to the first aperture of the second receptacle;
one or more barriers at least partially obstructing fluid flow between the first aperture and the second aperture, wherein each barrier of the one or more barriers include a plurality of perforations located along a width of the barrier and each of the plurality of perforations allows fluid to flow through the barrier.

2. The system of claim 1, further comprising a cavity located in the first receptacle, wherein the cavity is obstructed at one end by the first filter and the pump enclosed by the cavity and the first filter.

3. The system of claim 1, further comprising:
a U-shaped channel located in the first receptacle,
the U-shaped channel having a first end and a second end, wherein the second filter is located between the first end and the second end and:
the first end is configured to receive fluid from the second receptacle through the second aperture, and
the second end comprising a notch to facilitate fluid overflow into the first receptacle.

4. The system of claim 1, wherein the second receptacle is located at a higher vertical elevation than the first receptacle to facilitate gravity draining the fluid from the second receptacle to the first receptacle.

5. The system of claim 1, wherein the first receptacle stores a fluid containing biological waste from aquatic organisms.

6. The system of claim 1, wherein the second receptacle stores a solid media to facilitate plant growth.

7. The system of claim 1, wherein each of the plurality of perforations is spaced at regular intervals along the width of the barrier relative to adjacent perforations.

8. The system of claim 1, wherein each of the plurality of perforations is a vertical slot.

9. The system of claim 1, wherein each of the plurality of perforations is a circular opening.

10. The system of claim 1, further comprising a flexible hose coupled to the first aperture, the hose being configured to dispense fluid throughout the second receptacle and to dispose water from the second receptacle.

11. The system of claim 1, wherein the second receptacle further comprises:
a third aperture;
a first stand coupled to the third aperture; and
a second stand pipe coupled to the second aperture, wherein the first stand pipe provides overflow protection to the second stand pipe by having a free end that is higher in elevation than a free end of the second stand pipe.

12. The system of claim 1, wherein each of the first filter and the second filter comprises a plurality of different filter media blocks each having a different pore size.

13. The system of claim 1, wherein each of the first filter and the second filter comprises one selected from the group consisting of: gravel, pebbles, sand, soil, and woodchips.

14. An apparatus comprising:
a first receptacle comprising a first filter and a second filter;
a second receptacle comprising first aperture and a second aperture, wherein fluid can enter the second receptacle through the first aperture and drain from the second receptacle through the second aperture to the second filter in the first receptacle;
a pump configured to pump fluid from the first receptacle through the first filter to the first aperture of the second receptacle;
one or more barriers at least partially obstructing fluid flow between the first aperture and the second aperture, wherein each barrier of the one or more barriers include a plurality of perforations located along a width of the barrier and each of the plurality of perforations allows fluid to flow through the barrier.

15. The apparatus of claim 1, further comprising a cavity located in the first receptacle, wherein the cavity is obstructed at one end by the first filter and the pump enclosed by the cavity and the first filter.

16. The apparatus of claim 1, further comprising:
a U-shaped channel located in the first receptacle,
the U-shaped channel having a first end and a second end, wherein the second filter is located between the first end and the second end and:
the first end is configured to receive fluid from the second receptacle through the second aperture, and
the second end comprising a notch to facilitate fluid overflow into the first receptacle.

17. The apparatus of claim 1, wherein the second receptacle is located at a higher vertical elevation than the first receptacle to facilitate gravity draining the fluid from the second receptacle to the first receptacle.

18. The apparatus of claim 1, wherein the first receptacle stores a fluid containing biological waste from aquatic organisms.

19. The apparatus of claim 1, wherein the second receptacle stores a solid media to facilitate plant growth.

20. A method for filtering and distributing fluid in a planting device, the method comprising:
pumping fluid from a first receptacle to second receptacle, wherein the fluid enters the second receptacle through a first filter and drains from the second receptacle through a second filter the first receptacle
partially obstructing fluid flow between a first aperture and a second aperture in the second receptacle, wherein the fluid flow is distributed along a width of the second aperture based on the partial obstruction.
